(19) United States
(12) Patent Application Publication
(10) Pub. No.: US 2011/0132868 A1
(43) Pub. Date: Jun. 9, 2011

(54) Polishing composition for polishing silver and alumina, and polishing method using the same

(75) Inventor: Tetsuji Hori, Tokyo (JP)

(73) Assignee: TDK CORPORATION, TOKYO (JP)

(21) Appl. No.: 12/591,888

(22) Filed: Dec. 3, 2009

(51) Int. Cl. C09K 13/06; G11B 5/187; G11B 5/31

(52) U.S. Cl. 216/22; 252/79.4

(57) ABSTRACT

An object to be polished includes a support body and a silver thin film. The support body has a surface to be polished and a trench that opens in the surface to be polished. At least part of the support body, including the surface to be polished, is made of alumina. The silver thin film is formed to fill the trench of the support body. A polishing composition is for use in a process of polishing the silver thin film and the surface to be polished of the object to be polished by chemical mechanical polishing. The polishing composition contains silica abrasive grains, nitric acid, hydrogen peroxide, and benzotriazole. The polishing composition is such one that the polishing rate of silver divided by the polishing rate of alumina in the process of polishing is equal to or higher than 5.

### BACKGROUND OF THE INVENTION

1. Field of the Invention

The present invention relates to a polishing composition for use in the process of polishing a silver thin film and a surface to be polished of an object to be polished by chemical mechanical polishing, and a polishing method using the polishing composition. The object to be polished here includes a support body and the silver thin film. The support body has the surface to be polished and a trench that opens in the surface to be polished. At least part of the support body, including the surface to be polished, is made of alumina. The silver thin film is formed to fill the trench of the support body.

2. Description of the Related Art

Typically, a magnetic head for use in a magnetic recording device has such a structure that a reproducing head including a magnetoresistive element for reading and a recording head including an induction-type electromagnetic transducer for writing are stacked on a substrate. The substrate of the magnetic head is typically formed of alumina-titanium carbide (Al₂O₃—TiC, hereinafter referred to as AlTiC).

The magnetic head is typically manufactured by forming a plurality of head elements each including the reproducing head and the recording head on a wafer of AlTiC (hereinafter, referred to as AlTiC wafer) to fabricate a substructure, and cutting the substructure so that the plurality of head elements are separated from each other. In the process of manufacturing the magnetic head, the head elements are formed on the AlTiC wafer through various wafer processes as is the case with semiconductor devices on a silicon wafer. One of the wafer processes is a chemical mechanical polishing (hereinafter, referred to as CMP) process.

One of the major uses of the CMP process is to polish and flatten the top surface of an insulating film that is formed over a concavo-convex structure in the process of forming elements having a multilayer structure. This polishing is needed to avoid a focus shift during photoresist exposure when forming a patterned layer on the insulating film. An example of another use of the CMP process which has been increasing in importance recently is to polish a metal film and an insulating film in a damascene process where metal is embedded in trenches of the insulating film for the purpose of forming fine metal wiring. Hereinafter, the CMP process in the damascene process will be referred to as damascene CMP process. In the process of manufacturing a semiconductor device, the damascene CMP process is frequently used in forming copper wiring or tungsten plugs. The damascene CMP process for use in the process of manufacturing a semiconductor device is described in, for example, U.S. Pat. No. 6,555,466 B1, U.S. Pat. No. 6,821,309 B2, U.S. Patent Application Publication No. 200910215269 A1, and JP-A-2000-306912.

In the process of manufacturing a magnetic head, the damascene CMP process can be used when forming a coil or wiring of copper and when forming a magnetic pole or shield of a magnetic alloy. The components of the magnetic head to be formed with the damascene CMP process are not always finely structured, however. For that reason, not much importance has heretofore been given to the damascene CMP process in the manufacturing process of a magnetic head.

A magnetic recording medium in a magnetic recording device is a discrete medium made of an aggregate of magnetic fine particles, each magnetic fine particle forming a single-domain structure. A single recording bit of the magnetic recording medium is composed of a plurality of magnetic fine particles. To increase the recording density, it is necessary to reduce asperities at the borders between adjoining recording bits. To achieve this, the magnetic fine particles must be made smaller. However, making the magnetic fine particles smaller causes the problem that the thermal stability of magnetization of the magnetic fine particles decreases with decreasing volume of the magnetic fine particles. To solve this problem, it is effective to increase the anisotropic energy of the magnetic fine particles. However, increasing the anisotropic energy of the magnetic fine particles leads to an increase in coercivity of the magnetic recording medium, and this makes it difficult to perform data recording with existing magnetic heads.

To solve the foregoing problems, there has been proposed a technique so-called heat-assisted magnetic recording. This technique uses a magnetic recording medium having high coercivity. When recording data, a magnetic field and heat are simultaneously applied to the area of the magnetic recording medium where to record data, so that the area rises in temperature and drops in coercivity for data recording.

In heat-assisted magnetic recording, near-field light is typically used as a means for applying heat to the magnetic recording medium. A commonly known method for generating near-field light is to use a near-field light generating element or so-called plasmon antenna, which is a piece of metal that generates near-field light from plasmons excited by irradiation with light.

As a technique for exciting plasmons on the near-field light generating element, there has been proposed such a technique that light propagating through a waveguide is coupled with the near-field light generating element via a buffer layer in a surface plasmon polariton mode to thereby excite surface plasmons on the near-field light generating element. The near-field light generating element has a near-field light generating part which is a sharp-pointed part located in the medium facing surface to generate near-field light. According to this technique, the light propagating through the waveguide is totally reflected at the interface between the waveguide and the buffer layer to generate evanescent light permeating into the buffer layer. The evanescent light and collective oscillations of charges on the near-field light generating element, i.e., surface plasmons, are coupled with each other to excite the surface plasmons on the near-field light generating element. In the near-field light generating element, the excited surface plasmons propagate to the near-field light generating part, and near-field light occurs from the near-field light generating part.

In order to use the foregoing near-field light generating element and improve the use efficiency of light propagating through the waveguide, it is necessary to match the wave number of the evanescent light with the wave number of surface plasmons to be excited on the near-field light generating element so that the surface plasmons are resonantly excited by the evanescent light. The phenomenon that surface plasmons are resonantly excited by light will hereinafter be referred to as surface plasmon polariton coupling. The wave number of surface plasmons excited on the near-field light generating element varies according to the material and shape of the near-field light generating element. The selection of the material and shape for the near-field light generating element is thus critical to produce the surface plasmon polariton coupling to improve the use efficiency of the light propagating through the waveguide. Silver is one of known materials of the near-field light generating element that can produce surface plasmon polariton coupling.

The near-field light generating element can be formed by a method including: forming a trench in a support body that has a surface to be polished, wherein at least part of the support body including the surface to be polished is made of alumina; forming a silver thin film so as to fill the trench; and polishing the silver thin film and the surface to be polished by the damascene CMP process to form a near-field light generating element embedded in the trench of the support body. The damascene CMP process in such a forming method, however, has the following two problems.

A first problem is that there is no polishing composition suited to polish silver and alumina. More specifically, there is no proven polishing composition for polishing silver because silver is a metal that has not been so far involved in the manufacture of semiconductor devices or magnetic heads. Silver is a chemically stable metal, and it is therefore difficult to polish silver and alumina without imperfections when existing polishing compositions are used.

A second problem is that silver has an extremely low adhesion to alumina, and the silver thin film can therefore exfoliate from the support body during polishing.

### OBJECT AND SUMMARY OF THE INVENTION

It is an object of the present invention to provide a polishing composition that makes it possible to polish a silver thin film and a surface to be polished of an object to be polished by chemical mechanical polishing while suppressing the occurrence of imperfections, and a polishing method using the polishing composition. The object to be polished here includes a support body and the silver thin film. The support body has the surface to be polished and a trench that opens in the surface to be polished. At least part of the support body, including the surface to be polished, is made of alumina. The silver thin film is formed to fill the trench of the support body.

The polishing composition and the polishing method of the present invention are to be applied to an object to be polished that includes a support body and a silver thin film. The support body has a surface to be polished and a trench that opens in the surface to be polished. At least part of the support body, including the surface to be polished, is made of alumina. The silver thin film is formed to fill the trench of the support body. The polishing composition of the present invention is for use in a process of polishing the silver thin film and the surface to be polished of the object by chemical mechanical polishing. The polishing composition of the present invention contains silica abrasive grains, nitric acid, hydrogen peroxide, and benzotriazole. The polishing composition is such one that the polishing rate of silver divided by the polishing rate of alumina in the process of polishing is equal to or higher than 5. For example, the present invention can be used in forming a near-field light generating element of silver that is for use in heat-assisted magnetic recording. The present invention is not limited to such an application, however, and may be widely used in forming a structure where silver is embedded in a trench of a support body, at least part of which including a polished surface is made of alumina.

In the polishing composition of the present invention, preferably, the silica abrasive grains have a primary grain size in the range of 5 to 50 nm, the silica abrasive grain content is in the range of 0.1 to 10.0 wt %, and the nitric acid content is in the range of 0.01 to 2.00 wt %. The hydrogen peroxide content is preferably in the range of 0.1 to 2.0 wt %. The benzotriazole content is preferably in the range of 0.003 to 0.050 wt %.

The polishing composition of the present invention is preferably such one that the polishing rate of silver divided by the polishing rate of alumina in the process of polishing is in the range of 5 to 50.

The polishing composition of the present invention is more preferably such one that the polishing rate of silver divided by the polishing rate of alumina in the process of polishing is in the range of 5 to 20.

In the polishing composition of the present invention, more preferably, the silica abrasive grains have a primary grain size in the range of 5 to 50 nm, the silica abrasive grain content is in the range of 1.0 to 10.0 wt %, and the nitric acid content is in the range of 0.1 to 2.0 wt %. The hydrogen peroxide content is more preferably in the range of 0.5 to 1.5 wt %. The benzotriazole content is more preferably in the range of 0.005 to 0.050 wt %.

A concentrated polishing composition of the present invention is intended to be diluted by adding water to form the polishing composition of the present invention.

The polishing method of the present invention is a method for polishing the silver thin film and the surface to be polished of the object to be polished by chemical mechanical polishing. The polishing method of the present invention includes: supplying a polishing composition onto a polishing pad and placing the object to be polished on the polishing pad; and polishing the silver thin film and the surface to be polished by using the polishing pad and the polishing composition. The polishing composition contains silica abrasive grains, nitric acid, hydrogen peroxide, and benzotriazole. The polishing composition is such one that the polishing rate of silver divided by the polishing rate of alumina is equal to or higher than 5.

According to the polishing composition, the concentrated polishing composition and the polishing method of the present invention, it is possible to polish the silver thin film and the surface to be polished of the object to be polished by chemical mechanical polishing while suppressing the occurrence of imperfections.

Other and further objects, features and advantages of the invention will appear more fully from the following description.

### BRIEF DESCRIPTION OF THE DRAWINGS

FIG. 1 is a cross-sectional view showing a step of a polishing method according to an embodiment of the invention.

FIG. 2 is a cross-sectional view showing a step that follows the step shown in FIG. 1.

FIG. 3 is a cross-sectional view showing a step that follows the step shown in FIG. 2.

FIG. 4 is a cross-sectional view showing a step that follows the step shown in FIG. 3.

FIG. 5 is a cross-sectional view showing a step that follows the step shown in FIG. 4.

FIG. 6 is an explanatory diagram showing a polishing apparatus used in the polishing method according to the embodiment of the invention.

FIG. 7 is a perspective view showing an example of a near-field light generating device including a near-field light generating element that is formed by using the polishing method according to the embodiment of the invention.

FIG. 8 is an explanatory diagram for explaining the principle of heat-assisted magnetic recording.

FIG. 9 is a cross-sectional view showing a step of a method of forming the near-field light generating device shown in FIG. 7.

FIG. 10 is a cross-sectional view showing a step that follows the step shown in FIG. 9.

FIG. 11 is a cross-sectional view showing a step that follows the step shown in FIG. 10.

FIG. 12 is a cross-sectional view showing a step that follows the step shown in FIG. 11.

### DETAILED DESCRIPTION OF THE PREFERRED EMBODIMENT

A preferred embodiment of the present invention will now be described in detail with reference to the drawings. Initially, a description will be given of an example of the configuration of a magnetic head including a near-field light generating element that is formed by using a polishing composition, a concentrated polishing composition and a polishing method according to the embodiment of the invention. The magnetic head includes a substrate made of, for example, AlTiC, and a reproducing head and a recording head that are stacked on the substrate. The magnetic head has a medium facing surface that faces a magnetic recording medium. The reproducing head includes a magnetoresistive element for reading. The recording head includes an induction-type electromagnetic transducer for writing. The induction-type electromagnetic transducer includes a coil and a magnetic pole. The coil produces a magnetic field corresponding to data to be recorded on the magnetic recording medium. The magnetic pole has an end face located in the medium facing surface, and produces a recording magnetic field for recording data on the magnetic recording medium.

The recording head further includes a near-field light generating device. The near-field light generating device generates near-field light that is to be applied to the magnetic recording medium when data is recorded on the magnetic recording medium by using the recording magnetic field produced by the magnetic pole.

FIG. 7 is a perspective view showing an example of the near-field light generating device. Reference numeral 30 in FIG. 7 indicates the medium facing surface. The near-field light generating device 10 includes a waveguide 11 and a clad layer 12 that are disposed on a not-shown underlayer. The waveguide 11 has a not-shown incident end, an end face 11a that is closer to the medium facing surface 30, and a top surface 11b. The end face 11a is located at a distance from the medium facing surface 30. A part of the clad layer 12 is interposed between the end face 11a and the medium facing surface 30. The clad layer 12 has a top surface 12b. The top surface 11b of the waveguide 11 has a trench 11g that extends in a direction perpendicular to the medium facing surface 30. The top surface 12b of the clad layer 12 has a trench 12g that is continuous with the trench 11g and extends in the direction perpendicular to the medium facing surface 30.

The near-field light generating device 10 further includes a clad layer 13 disposed over the waveguide 11 and the clad layer 12. The clad layer 13 has a bottom surface 13a, a top surface 13b, and an opening 13c. The bottom surface 13a is in contact with the top surface 11b of the waveguide 11 and the top surface 12b of the clad layer 12. The top surface 13b is opposite to the bottom surface 13a. The opening 13c penetrates the clad layer 13 from the top surface 13b to the bottom surface 13a and is continuous with the trenches 11g and 12g.

The near-field light generating device 10 further includes a buffer layer 14 and a near-field light generating element 15. At least part of the near-field light generating element 15 is accommodated in the opening 13c. In the trench 11g, the trench 12g and the opening 13c, the buffer layer 14 is interposed between the near-field light generating element 15 and the waveguide 11, between the near-field light generating element 15 and the clad layer 12, and between the near-field light generating element 15 and the clad layer 13, respectively,

The waveguide 11, the clad layers 12 and 13, and the buffer layer 14 constitute a support part 16 that supports the near-field light generating element 15. The support part 16 has a top surface 16a, and a trench 16g that opens in the top surface 16a. The surface of the trench 16g is formed by the surface of the buffer layer 14. The cross section of the trench 16g parallel to the medium facing surface 30 is V-shaped. The near-field light generating element 15 is in the shape of a triangular prism. The near-field light generating element 15 has: an end face 15a located in the medium facing surface 30; an edge part 15b that is opposed to the trenches 11g and 12g with the buffer layer 14 interposed therebetween; and a near-field light generating part 15c that is located in the medium facing surface 30 and generates near-field light. The near-field light generating part 15c lies at an end of the edge part 15b that is located in the medium facing surface 30. Specifically, the near-field light generating part 15c refers to the end of the edge part 15b in the end face 15a and its vicinity. The edge part 15b includes a coupling portion 15b1 that is opposed to the trench 11g of the waveguide 11 with the buffer layer 14 interposed therebetween.

In the near-field light generating device 10, the waveguide 11 is made of tantalum oxide such as Ta₂O₅, for example. The clad layers 12 and 13 and the buffer layer 14 are made of alumina. The near-field light generating element 15 is made of silver.

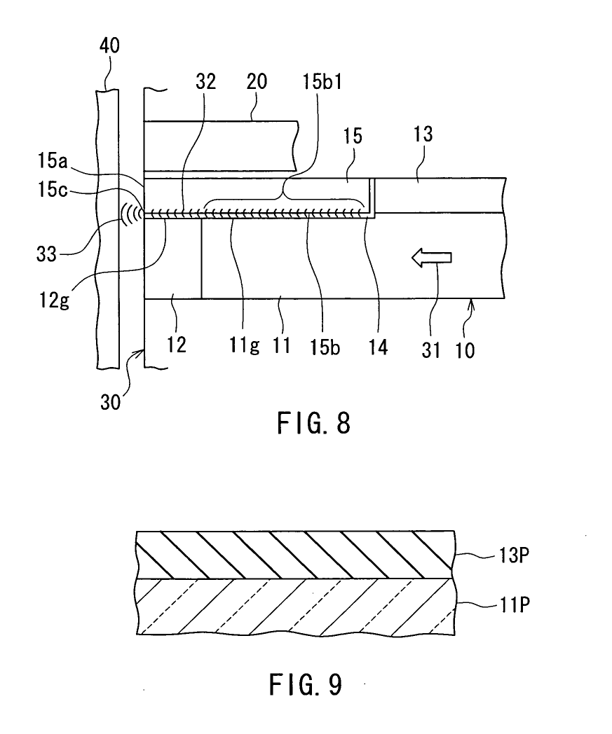

Reference is now made to FIG. 8 to describe the principle of generation of near-field light by the near-field light generating device 10 shown in FIG. 7 and the principle of heat-assisted magnetic recording using the near-field light. FIG. 8 shows a magnetic pole 20 and a magnetic recording medium 40, in addition to the near-field light generating device 10 of FIG. 7. The magnetic pole 20 is disposed above the near-field light generating element 15, with a predetermined spacing between the magnetic pole 20 and the top surface of the near-field light generating element 15.

In the near-field light generating device 10 shown in FIG. 8, laser light 31 that is emitted from a not-shown laser diode and incident on the incident end of the waveguide 11 propagates through the waveguide 11 to reach the vicinity of the buffer layer 14. Here, the laser light is totally reflected at the interface between the waveguide 11 and the buffer layer 14, and this generates evanescent light permeating into the buffer layer 14. Then, this evanescent light and fluctuations of charges in at least the coupling portion 15b1 of the outer surface of the near-field light generating element 15 are coupled with each other to induce a surface plasmon polariton mode, whereby surface plasmons are excited on at least the coupling portion 15b1 of the outer surface of the near-field light generating element 15.

The surface plasmons 32 excited on at least the coupling portion 15b1 of the outer surface of the near-field light generating element 15 propagate along the edge part 15b to reach the near-field light generating part 15c. As a result, the surface plasmons 32 concentrate at the near-field light generating part 15c, and near-field light 33 thus occurs from the near-field light generating part 15c based on the surface plasmons 32. The near-field light 33 is projected toward the magnetic recording medium 40, reaches the surface of the magnetic recording medium 40, and heats a part of the magnetic recording layer of the magnetic recording medium 40. This lowers the coercivity of the part of the magnetic recording layer. In heat-assisted magnetic recording, the part of the magnetic recording layer with the lowered coercivity is subjected to the recording magnetic field produced by the magnetic pole 20 for data recording.

A method of forming the near-field light generating element 15 shown in FIG. 7 will now be described with reference to FIG. 9 to FIG. 12. FIG. 9 to FIG. 12 each show a cross section of a stack of layers in the process of forming the near-field light generating element 15, the cross section being parallel to the medium facing surface 30.

FIG. 9 shows a step of the method of forming the near-field light generating element 15. In this step, an initial waveguide lip and a first dielectric layer (not shown) are initially formed. The initial waveguide 11P is intended to undergo the formation of the trench 11g therein later to thereby become the waveguide 11. The first dielectric layer is intended to undergo the formation of the trench 12g therein later to thereby become the clad layer 12. A second dielectric layer 13P is then formed over the initial waveguide 11P and the first dielectric layer. The second dielectric layer 13P is intended to undergo the formation of the opening 13c therein later to thereby become the clad layer 13.

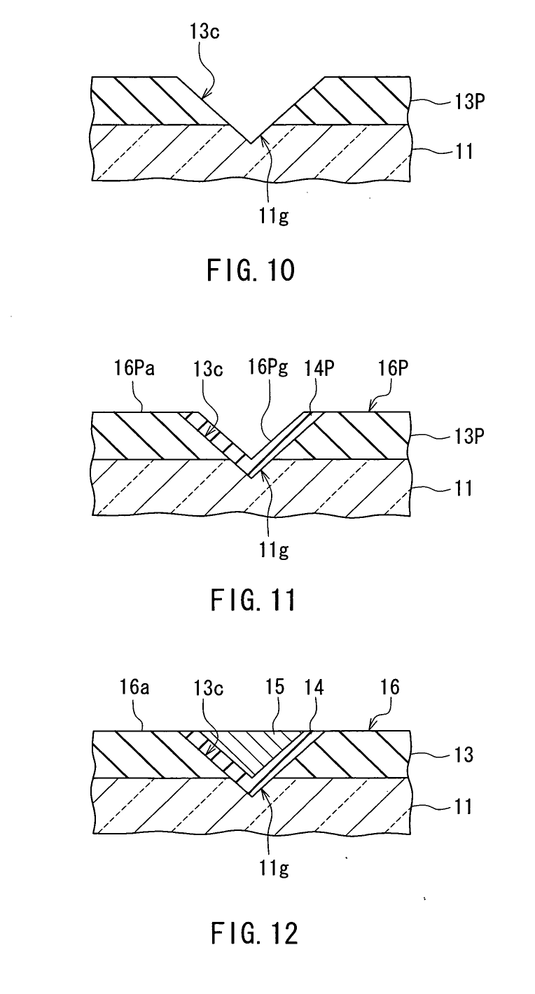

FIG. 10 shows the next step. In this step, the opening 13c and the trenches 11g and 12g are formed by partially etching the second dielectric layer 13P, the first dielectric layer and the initial waveguide 11P by ion milling or reactive ion etching, for example. This makes the initial waveguide 11P into the waveguide 11, and the first dielectric layer into the clad layer 12.

FIG. 11 shows the next step. In this step, an initial buffer layer 14P, which is to become the buffer layer 14 later, is formed in the opening 13c and the trenches 11g and 12g by sputtering, for example. The waveguide 11, the clad layer 12, the second dielectric layer 13P, and the initial buffer layer 14P thereby constitute a support body 16P. The support body 16P is to become the support part 16 later. The support body 16P has a surface to be polished 16Pa that corresponds to the top surface 16a of the support part 16, and a trench 16Pg that opens in the surface to be polished 16Pa. The cross section of the trench 16Pg parallel to the medium facing surface 30 is V-shaped. At least part of the support body 16P, including the surface to be polished 16Pa, is made of alumina.

FIG. 12 shows the next step. In this step, a silver thin film is initially formed by, for example, sputtering or plating, so as to fill the trench 16Pg and cover the surface to be polished 16Pa. For the purpose of improving the adhesion between the silver thin film and the initial buffer layer 14P of alumina, a thin adhesion layer of tantalum, titanium or the like may be formed over the initial buffer layer 14P so as to form the silver thin film over the adhesion layer. The adhesion layer shall have a thickness as small as not to cause a large drop in the efficiency of conversion of the laser light into near-field light. Next, the silver thin film and the surface to be polished 16Pa are polished by CMP. This polishing makes the surface 16Pa into the top surface 16a, the support body 16P into the support part 16, and the silver thin film into the near-field light generating element 15. This polishing also flattens the top surface 16a of the support part 16 and the top surface of the near-field light generating element 15.

When forming the near-field light generating element 15 through the steps shown in FIG. 9 to FIG. 12, the polishing composition, the concentrated polishing composition and the polishing method according to the present embodiment are applicable to the step of polishing the silver thin film and the surface to be polished 16Pa by CMP as shown in FIG. 12, for example.

Here, a detailed description will be given of the polishing composition, the concentrated polishing composition and the polishing method according to the present embodiment. The polishing composition according to the present embodiment is to be applied to an object to be polished that includes a support body and a silver thin film. The support body has a surface to be polished, and a trench that opens in the surface to be polished. At least part of the support body, including the surface to be polished, is made of alumina. The silver thin film is formed to fill the trench of the support body. The polishing composition according to the present embodiment is for use in the process of polishing the silver thin film and the surface to be polished of the object by CMP.

The polishing composition according to the present embodiment contains silica abrasive grains, nitric acid, hydrogen peroxide, and benzotriazole (hereinafter, referred to as BTA). The polishing composition according to the present embodiment further contains water and is in a slurry form. The polishing composition according to the present embodiment is such one that the polishing rate of silver divided by the polishing rate of alumina (hereinafter, referred to as silver/alumina polishing selectivity) in the foregoing process is equal to or higher than 5. In the polishing composition according to the present embodiment, hydrogen peroxide is used as an oxidizing agent, and BTA is used as a rust inhibitor.

In the polishing composition according to the present embodiment, preferably, the silica abrasive grains have a primary grain size in the range of 5 to 50 nm, the silica abrasive grain content is in the range of 0.1 to 10.0 wt %, and the nitric acid content is in the range of 0.01 to 2.00 wt %. In the polishing composition according to the present embodiment, the hydrogen peroxide content is preferably in the range of 0.1 to 2.0 wt %. In the polishing composition according to the present embodiment, the BTA content is preferably in the range of 0.003 to 0.050 wt %. The meanings of the plurality of components of the polishing composition according to the present embodiment will be detailed later.

The concentrated polishing composition according to the present embodiment is intended to be diluted by adding water to form the polishing composition according to the present embodiment. The absolute amount and weight concentration of water contained in the concentrated polishing composition are thus less/lower than those of water contained in the polishing composition according to the present embodiment. In the, concentrated polishing composition, silica abrasive grains, nitric acid, hydrogen peroxide, and BTA have respective weight concentrations higher than in the polishing composition.

The polishing method according to the present embodiment is a method for polishing the silver thin film and the surface to be polished of the foregoing object to be polished by CMP. The method includes: supplying the polishing composition according to the present embodiment onto a polishing pad and placing the object to be polished on the polishing pad; and polishing the silver thin film and the surface to be polished by using the polishing pad and the polishing composition.

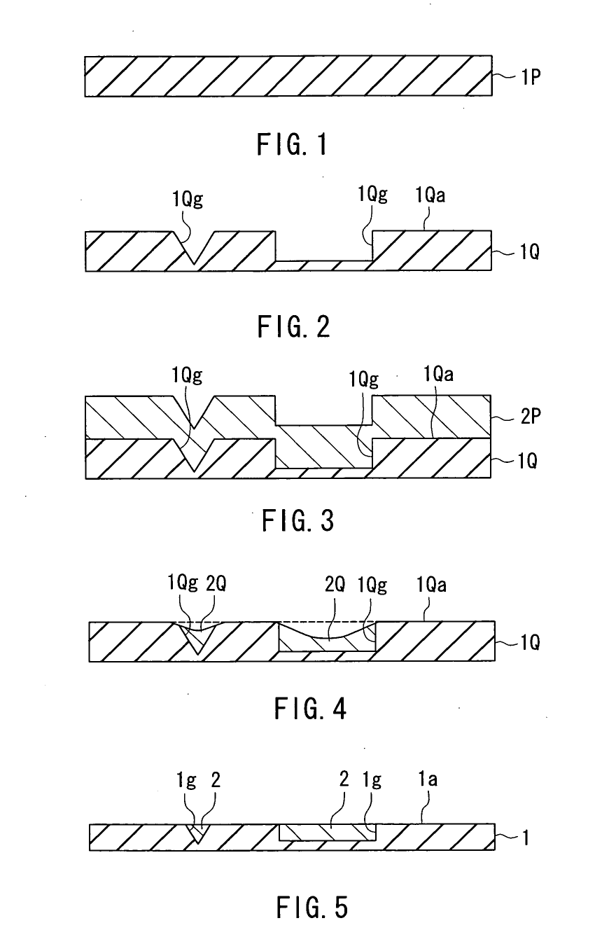

With reference to FIG. 1 to FIG. 5, a description will now be given of a method of forming a structure by using the polishing composition and the polishing method according to the present embodiment. The structure here includes a support part and devices. The support part has a top surface, and trenches that open in the top surface. The devices are made of silver embedded in the trenches of the support part. At least part of the support part, including the top surface, is made of alumina. A concrete example of the devices made of silver is the near-field light generating element 15 shown in FIG. 7.

FIG. 1 is a cross-sectional view showing a step of the method of forming the structure. In this step, an insulating layer 1P of alumina is formed on a not-shown underlayer.

FIG. 2 shows the next step. In this step, first, a not-shown mask is formed on the insulating layer 1P. The mask has openings at the positions corresponding to the trenches to be formed later in the insulating layer 1P. The mask is formed by patterning a photoresist layer by photolithography. Next, the parts of the insulating layer 1P corresponding to the openings of the mask are etched by ion milling or reactive ion etching, for example. The trenches 1Qg are thereby formed in the insulating layer 1P. By way of example, FIG. 2 shows a case where two trenches 1Qg having different widths are formed in the insulating layer 1P. Having undergone the formation of the trenches 1Qg therein, the insulating layer 1P becomes a support body 1Q. The support body 1Q has a surface to be polished 1Qa, and the trenches 1Qg that open in the surface to be polished 1Qa. The surface 1Qa is to be polished later.

FIG. 3 shows the next step. In this step, a silver thin film 2P is initially formed by, for example, sputtering or plating, so as to fill the trenches 1Qg and cover the surface to be polished 1Qa. For the purpose of improving the adhesion between the support body 1Q of alumina and the silver thin film 2P, a thin adhesion layer of tantalum, titanium, or the like may be formed to cover the surfaces of the trenches 1Qg, and then the silver thin film 2P may be formed on the adhesion layer. In the case of forming a near-field light generating element of silver on the buffer layer of alumina as shown in FIG. 12, the adhesion layer shall have a thickness as small as not to cause a large drop in the efficiency of conversion of laser light into near-field light.

The laminate including the support body 1Q and the silver thin film 2P shown in FIG. 3 is the object to be polished of the present embodiment. In the object to be polished shown in FIG. 3, the support body 1Q is entirely made of alumina. In the present embodiment, however, the object to be polished requires only that at least part of the support body 1Q, including the surface to be polished 1Qa, be made of alumina.

FIG. 4 shows the next step. In this step, the silver thin film 2P and the surface to be polished 1Qa are polished by using the polishing method according to the present embodiment so that the portions of the silver thin film 2P lying on the surface 1Qa are removed completely and silver thin films 2Q only remain in the trenches 1Qg. What is important in this step is to remove as much silver and as little alumina as possible, i.e., to increase the silver/alumina polishing selectivity.

Note that the surface of the object to be polished will not necessarily be polished uniformly. Considering this, it is necessary to perform overpolishing in order to remove the portions of the silver thin film 2P lying on the surface 1Qa completely so that the silver thin films 2Q only remain in the trenches 1Qg. The overpolishing polishes off the silver thin film 2P more than a required amount of polishing that is estimated from the initial thickness of the silver thin film 2P on the assumption of uniform polishing. Hereinafter, the actual amount of polishing by the overpolishing minus the required amount of polishing will be referred to as the amount of overpolishing. The overpolishing may produce recesses called dishing or erosion in the polished surface, depending on the density and width of the pattern of the trenches 1Qg. FIG. 4 shows the state where the polished surface has dishing. Although not shown, erosion can occur in areas where the trenches 1Qg have a high pattern density.

The occurrence of imperfections such as dishing and erosion can be suppressed to some degree by forming a protective coating over the surface of the object to be polished out of BTA that is contained in the polishing composition, or by providing an appropriate dummy pattern. Alternatively, the trenches 1Qg may initially be formed deeper than ultimately necessary. In such a case, the occurrence of the foregoing imperfections can be suppressed by performing the polishing shown in FIG. 4 as primary polishing, and then performing secondary polishing as shown in FIG. 5 by using a polishing composition that provides a silver/alumina polishing selectivity of 1 or near 1. The secondary polishing makes the support body 1Q into a support part 1, and the silver thin films 2Q into devices 2. The support part 1 has a top surface 1a, and trenches 1g that open in the top surface 1a. The devices 2 are made of silver embedded in the trenches 1g of the support part 1.

Note that the support body 1Q and the silver thin films 2Q after the polishing step of FIG. 4 may be taken as the support part 1 and the devices 2, respectively, without the secondary polishing.

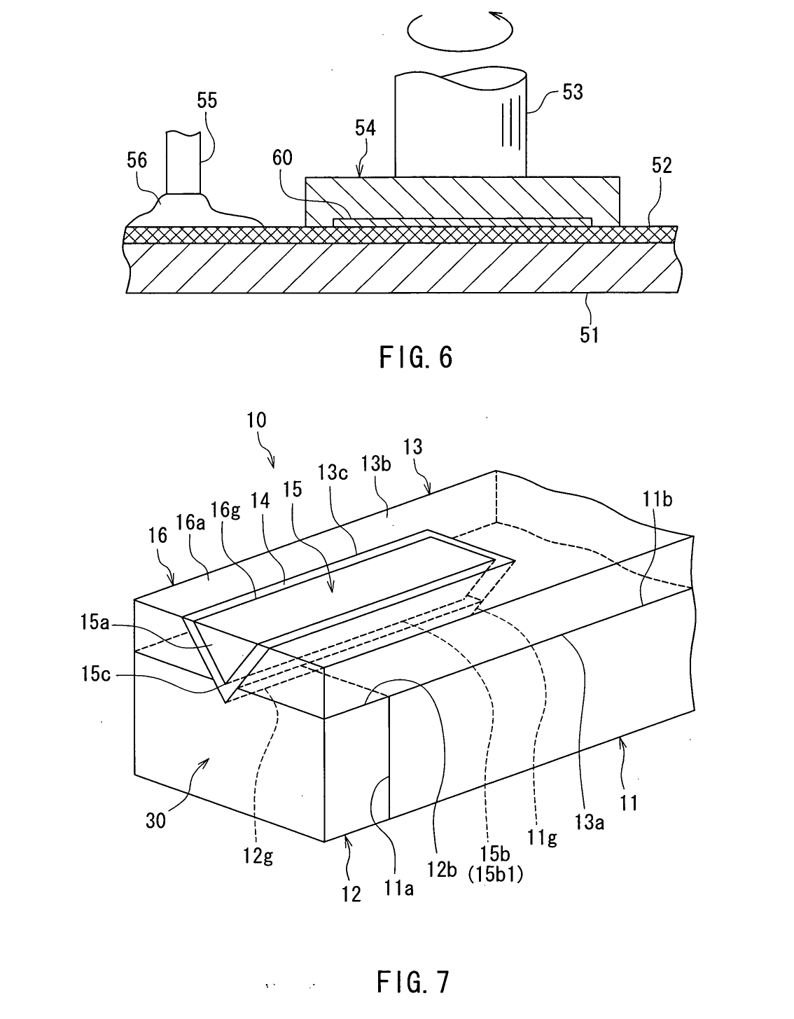

Reference is now made to FIG. 6 to describe an example of polishing apparatus for use in the polishing method according to the present embodiment. The polishing apparatus shown in FIG. 6 includes: a platen 51 to be driven to rotate; a polishing pad 52 provided on the platen 51; a rotary drive shaft 53 provided above the polishing pad 52 and extending in the vertical direction; a processing head 54 attached to the lower end of the rotary drive shaft 53; and a nozzle 55 for supplying a polishing composition (slurry) 56 onto the polishing pad 52. The processing head 54 holds an object to be polished 60 that is placed on the polishing pad 52. The object to be polished 60 includes the support body 1Q and the silver thin film 2P shown in FIG. 3.

In the polishing method according to the present embodiment that uses the polishing apparatus shown in FIG. 6, the object to be polished 60 is placed on the polishing pad 52 so that the silver thin film 2P comes in contact with the polishing pad 52, and the object 60 is held by the processing head 54. The polishing composition 56 according to the present embodiment is supplied onto the polishing pad 52 from the nozzle 55. Then, the platen 51 and the polishing pad 52 are driven to rotate, and the rotary drive shaft 53 and the processing head 54 are also driven to rotate. Consequently, the object to be polished 60 is polished by the polishing pad 52 and the polishing composition 56.

The polishing apparatus for use in the polishing method according to the present embodiment may have a configuration other than that shown in FIG. 6. For example, the polishing apparatus may be configured so that the processing head 54 is driven to rotate on a belt-shaped polishing pad that is driven in the horizontal direction.

Next, a description will be given of the meanings of the plurality of components of the polishing composition according to the present embodiment. The plurality of components of the polishing composition according to the present embodiment have been determined based on experiments and studies carried out by the inventor. The experiments and studies will now be described. Since silver has an extremely low adhesion to alumina, the inventor initially conceived inserting a thin adhesion layer between alumina and silver to fabricate an experimental object to be polished. Given the near-field light generating device 10 shown in FIG. 7 where the buffer layer 14 of alumina is interposed between the waveguide 11 and the near-field light generating element 15 of silver, however, the insertion of an adhesion layer between alumina and silver, i.e., between the buffer layer 14 and the near-field light generating element 15, would weaken the surface plasmon polariton coupling. The adhesion layer employable for such a configuration is therefore inevitably limited in material and thickness. Considering this point, the inventor fabricated an experimental object to be polished wherein a 1.5-nm-thick tantalum layer was inserted as the adhesion layer between alumina and silver. If a 1.5-nm-thick tantalum layer is inserted between the buffer layer 14 and the near-field light generating element 15 of the near-field light generating device 10 shown in FIG. 7, the efficiency of conversion of laser light into near-field light is expected to drop by about 20% as compared with the case where the tantalum layer is not inserted.

For an experiment, a 360-nm-thick alumina film was formed on an AlTiC wafer, and then a 1.5-nm-thick tantalum layer and a 400-nm-thick silver thin film were formed in this order over the alumina film to fabricate an experimental object to be polished.

In the experiment, the silver thin film of the experimental object to be polished was subjected to CMP using commercially-available ordinary polishing compositions (slurries) of first to third types. The polishing composition of the first type was a composition of cationic additive type for polishing alumina thin films, containing alumina abrasive grains. The polishing composition of the second type was a composition of anionic additive type for polishing alumina thin films, containing alumina abrasive grains. The polishing composition of the third type was a composition of cationic additive type for polishing silica thin films, containing fumed silica abrasive grains.

In the experiment, the use of the polishing composition of the first type and the polishing composition of the second type resulted in the exfoliation of the silver thin film across the entire surface of the experimental object. The exfoliation of the silver thin film was not resolved even when the polishing down force was lowered to the control limit of the polishing machine to reduce the shear stress at the surface of the experimental object.

With the polishing composition of the third type, on the other hand, the exfoliation of the silver thin film was kept partial by lowering the polishing down force. The amount of polishing in the not-exfoliating portions of the silver thin film, however, did not reach an acceptable level for the damascene CMP process.

From the experimental results, it was found that a desirable polishing composition (slurry) to be used in polishing a silver thin film by CMP should contain silica abrasive grains. It was also found, however, that a satisfactory silver polishing rate is difficult to achieve under the foregoing condition alone. Some chemical action for promoting the polishing of silver is therefore considered necessary for the polishing composition to be used in polishing a silver thin film.

Nitric acid is known as a typical chemical substance that has a dissolving action on silver. Silver was then experimentally examined for the rate of dissolution (hereinafter, referred to as etching rate) in dilute nitric acid of 0.5 wt %. The result showed that silver does dissolve but with an extremely low etching rate.

Next, silver was examined for the etching rate in dilute nitric acid of 0.5 wt % with additional hydrogen peroxide as much as 1.0 wt %. This showed an etching rate as high as 1000 nm/min or above at room temperatures. Hydrogen peroxide functions as an oxidizing agent.

From the foregoing, it was shown that nitric acid as dilute as can be handled as a polishing composition is not oxidative enough to increase the silver polishing rate. To provide a practical silver polishing rate, it seems effective to add hydrogen peroxide as an oxidizing agent to the polishing composition along with nitric acid. It was also found, however, that when the silver thin film was polished by CMP using the polishing composition that contained silica abrasive grains only with nitric acid and hydrogen peroxide as additives, the polished surface of the silver thin film became coarse, and etch pits developed in the crystal defects of the silver thin film which inevitably occurred during deposition.

In order to prevent the development of etch pits in a polished metal surface and provide a margin for overpolishing in the damascene CMP process, it is a typical practice to add a rust inhibitor, typified by BTA, to the polishing composition. In view of this, silver was then examined for the etching rate in dilute nitric acid of 0.5 wt % with additional hydrogen peroxide as much as 1.0 wt % and BTA of 1.0 wt % or less. As a result, the etching rate fell to almost zero when BTA was added by 0.1 wt % or more, showing that BTA formed a protective coating of considerable strength over the surface of the silver thin film.

From the above-described experiments and studies, it is expected that a polishing composition that contains silica abrasive grains, nitric acid, hydrogen peroxide, and BTA would be effective in enabling a damascene CMP process that is particularly intended to polish a silver thin film and a surface to be polished of an object to be polished that includes a support body and the silver thin film (such a process will hereinafter be referred to as silver damascene CMP process). Here, the support body has the surface to be polished and a trench that opens in the surface to be polished. The silver thin film is formed to fill the trench of the support body. At least part the support body, including the surface to be polished, is made of alumina. It is also expected that adjusting the respective contents of the components in the polishing composition allows controlling the silver/alumina polishing selectivity according to the purpose of the silver damascene CMP process.

Next, the silver/alumina polishing selectivity and the silver polishing rate in the polishing method according to the present embodiment will be discussed. In the silver damascene CMP process described above, the silver thin film of the object to be polished, where the silver thin film is formed to fill the trench of the support body and cover the surface to be polished of the support body, needs to be polished so that excessive portions of the silver thin film are removed to leave silver only in the trench. In such a case, the precondition is to remove as much silver and as little alumina as possible. The polishing composition according to the present embodiment is thus desired to be capable of increasing the silver/alumina polishing selectivity as much as possible.

The surface of the object to be polished will not necessarily be polished uniformly. Considering this, overpolishing is needed in order to remove the excessive portions of the silver thin film completely and leave silver only in the trench by using the polishing composition according to the present embodiment. The overpolishing can produce imperfections called dishing or erosion, depending on the density and width of the trench pattern.

The occurrence of the foregoing imperfections can be effectively suppressed by forming a protective coating over the surface of the object to be polished, out of the rust inhibitor that is contained in the polishing composition. Such measures by itself may sometimes be insufficient, however, depending on the configuration of the trench pattern. In such a case, it is effective to perform primary polishing by using a polishing composition with a high silver/alumina polishing selectivity, followed by secondary polishing by using a polishing composition with a silver/alumina polishing selectivity of, for example, 1 or near 1. While the amount of polishing required of the secondary polishing is determined by the degree of dishing or erosion caused by the primary polishing, typically, 1/10 or less the amount of polishing in the primary polishing is sufficient for the secondary polishing. It is therefore expected that a polishing composition that provides not so high a polishing rate may be used for the secondary polishing with no practical problem. The polishing composition for the primary polishing, on the other hand, needs to provide at least a high silver/alumina polishing selectivity and a high silver polishing rate. In the case of performing the primary polishing and the secondary polishing, the polishing composition and the polishing method according to the present embodiment are to be used for the primary polishing.

From the foregoing discussion, it is shown that a high silver/alumina polishing selectivity and a high silver polishing rate are desired of the polishing method according to the present embodiment. The silver/alumina polishing selectivity in the present embodiment is preferably 5 or higher. As will be described later, the silver/alumina polishing selectivity in the present embodiment is more preferably in the range of 5 to 50, and still more preferably in the range of 5 to 20. Suppose, for example, that the polishing method according to the present embodiment is applied to the method of forming the near-field light generating element 15 shown in FIG. 9 to FIG. 12. In such a case, the silver polishing rate in the present embodiment is, in practical terms, preferably 100 nm/min or higher, considering the depth of the trenches in the support body and the initial thickness of the silver thin film necessary to fill the trenches. According to the present embodiment, it is possible to achieve the preferred silver/alumina polishing selectivity and silver polishing rate mentioned above by controlling the respective contents of the components, i.e., silica abrasive grains, nitric acid, hydrogen peroxide, and BTA, in the polishing composition.

In the present embodiment, the preferred silver/alumina polishing selectivity and silver polishing rate are achievable by controlling the respective contents of the components in the polishing composition. This will hereinafter be described concretely.

A description will initially be given of an experiment that was performed to determine the preferred content ranges of the components of the polishing composition according to the present embodiment. In the experiment, a single film of silver or alumina was formed over AlTiC wafers to fabricate experimental objects to be polished. The silver or alumina films of the experimental objects to be polished were then polished by CMP, using each of a plurality of polishing compositions that contained the plurality of components in respective different combinations of contents. The silver polishing rate and the silver/alumina polishing selectivity were examined for each combination of the contents of the plurality of components.

The result showed that a silver polishing rate of 100 nm/min or higher and a silver/alumina polishing selectivity of 5 or higher can be achieved by the use of a polishing composition that contains the following components dispersed in water: silica abrasive grains of low mechanical polishing power, with a primary grain size in the range of 5 to 50 nm and a content of 0.1 to 10.0 wt %; nitric acid with a content of 0.01 to 2.00 wt %; hydrogen peroxide with a content of 0.1 to 2.0 wt %; and BTA with a content of 0.003 to 0.050 wt %. The foregoing ranges are therefore the preferred content ranges of the respective components.

The silica abrasive grain content is more preferably in the range of 1.0 to 10.0 wt %. The nitric acid content is more preferably in the range of 0.1 to 2.0 wt %, and still more preferably in the range of 0.3 to 0.5 wt %. The hydrogen peroxide content is more preferably in the range of 0.5 to 1.5 wt %. The BTA content is more preferably in the range of 0.005 to 0.050 wt %, and still more preferably in the range of 0.005 to 0.10 wt %.

For example, when a polishing composition containing 5.0 wt % of silica abrasive grains with a primary grain size of 12 nm, 0.5 wt % of nitric acid, 1.0 wt % of hydrogen peroxide, and 0.010 wt % of BTA was used to polish the experimental object to be polished under the polishing condition described below, a silver polishing rate of 288.4 nm/min and a silver/alumina polishing selectivity of 8.85 resulted.

The polishing condition was as follows. The polishing apparatus used was a CMP system ChaMP232C (product name) from Tokyo Seimitsu Co., Ltd. The polishing down force applied was 13.8 kPa. The linear velocity of the platen at the center of the surface to be polished of the experimental object was 110 m/min. The polishing pad used was IC1400 (product name) from Nitta Haas Inc. The dresser used was MD100-PC6 (product name) from Noritake Co., Limited.

A silver polishing rate and a silver/alumina polishing selectivity higher than their respective preferred ranges can also be provided by adjusting the respective contents of the components in the polishing composition. This may cause adverse effects, however. For example, when the experimental object to be polished was polished by using a polishing composition that contained silica abrasive grains, nitric acid and hydrogen peroxide within the foregoing respective preferred ranges but no BTA, there resulted a silver polishing rate of 2923 nm/min and a silver/alumina polishing selectivity of 165. However, a lot of etch pits developed in the polished surface of silver. If overpolishing is performed in this case, even more etch pits will develop due to the occurrence of dishing or erosion. Polishing without imperfections is thus expected to be difficult under such a condition. For that reason, the polishing composition according to the present embodiment needs to contain BTA.

Hereinafter, a description will be given of experiments on a plurality of practical examples of the present embodiment and a plurality of comparative examples.

### EXAMPLES 1 TO 18

Examples 1 to 18 are all practical examples of the polishing composition according to the present embodiment. The polishing compositions of examples 1 to 18 were prepared from nitric acid, BTA, hydrogen peroxide, commercially-available colloidal silica abrasive grains, and water. The nitric acid, BTA, and hydrogen peroxide used were all from Kanto Chemical Co., Inc. The colloidal silica abrasive grains used were either ones having a primary grain size of 12 nm or ones having a primary grain size of 36 nm. Specifically, the colloidal silica abrasive grains with a primary grain size of 12 nm were sol-gel processed super high purity synthetic colloidal silica PL-1H (product name) from Fuso Chemical Co., Ltd. The colloidal silica abrasive grains with a primary grain size of 36 nm were sol-gel processed super high purity synthetic colloidal silica PL-3 (product name) from the same company.

For the experiment, a single film of silver or alumina was formed over AlTiC wafers to fabricate experimental objects to be polished. Before the formation of the silver film, a 5-nm-thick adhesion layer of tantalum was formed as an underlayer of the silver film. In the experiment, the silver or alumina films of the experimental objects to be polished were polished by CMP, using the polishing compositions of examples 1 to 18. For each example, the silver polishing rate and the alumina polishing rate were determined to calculate the silver/alumina polishing selectivity. In the experiment, the polished surface of silver was checked for etch pits with respect to each example.

The polishing condition for the experiment was as follows. The polishing apparatus used was a CMP system ChaMP232C (product name) from. Tokyo Seimitsu Co., Ltd. The polishing down force applied was 13.8 kPa. The linear velocity of the platen at the center of the surface to be polished of the experimental object was 110 m/min. The polishing pad used was IC1400 (product name) from Nitta Haas Inc. The dresser used was MD100-PC6 (product name) from Noritake Co., Limited.

In the experiment, the silver or alumina polishing rate was determined in the following way. Initially, each experimental object to be polished was measured for thickness before and after polishing, by using a sheet resistance meter (VR120S (product name) from Hitachi Kokusai Denki Engineering Co., Ltd.) and an optical film thickness meter (NanoSpec Model.9200 (product name) from Nanometrics Japan. Ltd.). The silver or alumina polishing rate was then determined from a difference in thickness between before and after polishing, and the polishing time.

In the experiment, the polished surface of silver was observed to check the status of occurrence of etch pits therein in the following way. Initially, the surface of the experimental object polished was divided into ten regions of almost equal area, and each region was checked for etch pits. The statuses of occurrence of etch pits were classified into the following three. A first status is the status where the number of regions in which etch pit occurred is two or less. A second status is the status where the number of regions in which etch pit occurred is three to seven. A third status is the status where the number of regions in which etch pit occurred is eight or more.

Table 1 shows the experimental results for examples 1 to 18. In Table 1, the leftmost field indicates the example number. The field “SiO2 (12)” indicates the content (wt %) of colloidal silica abrasive grains with a primary grain size of 12 nm. The field “SiO2 (36)” indicates the content (wt %) of colloidal silica abrasive grains with a primary grain size of 36 nm. The fields “HNO3,” “BTA,” and “H2O2” indicate the contents (wt %) of nitric acid, BTA, and hydrogen peroxide, respectively. The fields “Ag-R.R.” and “Al2O3-R.R.” indicate the polishing rates (nm/min) of silver and alumina, respectively. The field “Ag/Al2O3” indicates the silver/alumina polishing selectivity. The field “Pit” indicates the status of occurrence of etch pits in the polished surface of silver. In this field, the first, second, and third statuses mentioned above are shown by the symbols ◯, Δ, and ×, respectively.

TABLE 1

| | SiO2 | SiO2 | | | | | Al2O3- | Ag/ | |
|---|---|---|---|---|---|---|---|---|---|
| | (12) | (36) | HNO3 | BTA | H2O2 | Ag-R.R. | R.R. | Al2O3 | Pit |
| 1 | 10.00 | — | 0.50 | 0.005 | 1.00 | 691.722 | 45.180 | 15.31 | Δ |
| 2 | 5.00 | — | 0.50 | 0.005 | 1.00 | 614.798 | 33.966 | 18.10 | Δ |
| 3 | 3.00 | — | 0.50 | 0.005 | 1.00 | 545.366 | 27.962 | 19.50 | Δ |
| 4 | 1.00 | — | 0.50 | 0.005 | 1.00 | 269.581 | 16.934 | 15.92 | Δ |
| 5 | 0.10 | — | 0.50 | 0.005 | 1.00 | 56.562 | 11.254 | 5.03 | Δ |
| 6 | — | 5.00 | 0.50 | 0.005 | 1.00 | 189.134 | 35.267 | 5.36 | ◯ |
| 7 | — | 3.00 | 0.50 | 0.005 | 1.00 | 170.061 | 29.142 | 5.84 | ◯ |
| 8 | 5.00 | — | 0.50 | 0.050 | 1.00 | 77.151 | 15.376 | 5.02 | ◯ |
| 9 | 5.00 | — | 0.50 | 0.010 | 1.00 | 288.442 | 32.603 | 8.85 | ◯ |
| 10 | 5.00 | — | 0.50 | 0.003 | 1.00 | 1248.747 | 35.324 | 35.35 | X |
| 11 | 5.00 | — | 2.00 | 0.005 | 1.00 | 3871.203 | 24.843 | 155.83 | X |
| 12 | 5.00 | — | 0.25 | 0.005 | 1.00 | 587.271 | 35.538 | 16.53 | Δ |
| 13 | 5.00 | — | 0.10 | 0.005 | 1.00 | 497.812 | 43.238 | 11.51 | ◯ |
| 14 | 5.00 | — | 0.01 | 0.005 | 1.00 | 249.329 | 49.374 | 5.05 | ◯ |
| 15 | 5.00 | — | 0.50 | 0.005 | 2.00 | 483.125 | 28.000 | 17.25 | Δ |
| 16 | 5.00 | — | 0.50 | 0.005 | 0.50 | 415.319 | 18.741 | 22.16 | Δ |
| 17 | 5.00 | — | 0.50 | 0.005 | 0.30 | 299.902 | 17.020 | 17.62 | Δ |
| 18 | 5.00 | — | 0.50 | 0.005 | 0.10 | 182.103 | 17.955 | 10.14 | ◯ |

### COMPARATIVE EXAMPLES 1 TO 3

Polishing compositions of comparative examples 1 to 3 were prepared by diluting the respective following products with water to double in weight: TKH-34P (product name), a typical commercially-available acidic polishing composition containing alumina abrasive grains, from Baikowski Japan Co., Ltd.; KZ-50 (product name), a typical commercially-available basic polishing composition containing alumina abrasive grains, from Baikowski Japan Co., Ltd.; and SS-25E (product name), a typical commercially-available basic polishing composition containing silica abrasive grains, from Cabot Microelectronics Japan K.K. Under the same condition as in examples 1 to 18, the silver film of the experimental object to be polished was polished by CMP using the polishing compositions of comparative examples 1 to 3. As a result, every one of the comparative examples 1 to 3 showed the exfoliation of silver in the entire surface or a part of the surface of the experimental object polished.

### COMPARATIVE EXAMPLES 4 TO 13

Polishing compositions of comparative examples 4 to 13 all contained colloidal silica abrasive grains and water, but not necessarily nitric acid, BTA, or hydrogen peroxide. The colloidal silica abrasive grains used in the polishing compositions of comparative examples 4 to 13 were any of the following: abrasive grains with a primary grain size of 12 nm used in examples 1 to 18; abrasive grains with a primary grain size of 36 nm; and abrasive grains with a primary grain size of 90 nm. The colloidal silica abrasive grains with a primary grain size of 12 nm and ones with a primary grain size of 36 nm were the same as those used in examples 1 to 18. The colloidal silica abrasive grains with a primary grain size of 90 nm, to be more specific, were sol-gel processed super high purity synthetic colloidal silica PL-10H (product name) from Fuso Chemical Co., Ltd. In the experiment, the silver or alumina films of the experimental objects to be polished were polished by CMP, using the polishing compositions of comparative examples 4 to 13 under the same condition as in examples 1 to 18. For each comparative example, the silver polishing rate and the alumina polishing rate were determined to calculate the silver/alumina polishing selectivity. In the experiment, the polished surface of silver was checked for etch pits with respect to each comparative example. Table 2 shows the experimental results for comparative examples 4 to 13. In Table 2, the leftmost field indicates the comparative example number. The field “SiO2 (90)” indicates the content (wt %) of colloidal silica abrasive grains with a primary grain size of 90 nm. The other fields of Table 2 have the same meanings as in Table 1.

TABLE 2

| | SiO2 | SiO2 | SiO2 | | | | | Al2O3- | Ag/ | |
|---|---|---|---|---|---|---|---|---|---|---|
| | (12) | (36) | (90) | HNO3 | BTA | H2O2 | Ag-R.R. | R.R. | Al2O3 | Pit |
| 4 | — | 1.00 | — | 0.50 | 0.005 | 1.00 | 82.359 | 17.975 | 4.58 | ◯ |
| 5 | — | — | 10.00 | 0.50 | 0.005 | 1.00 | 71.222 | 39.806 | 1.79 | ◯ |
| 6 | — | — | 5.00 | 0.50 | 0.005 | 1.00 | 54.196 | 35.312 | 1.53 | ◯ |
| 7 | — | — | 3.00 | 0.50 | 0.005 | 1.00 | 32.344 | 28.709 | 1.13 | ◯ |
| 8 | — | — | 1.00 | 0.50 | 0.005 | 1.00 | 23.581 | 21.127 | 1.12 | ◯ |
| 9 | 5.00 | — | — | 0.50 | 0.100 | 1.00 | 44.870 | 17.279 | 2.60 | ◯ |
| 10 | 5.00 | — | — | — | 0.005 | 1.00 | 44.581 | 81.576 | 0.55 | ◯ |
| 11 | 5.00 | — | — | 0.50 | 0.005 | — | 46.355 | 17.583 | 2.64 | ◯ |
| 12 | 5.00 | — | — | — | — | — | 91.283 | 104.997 | 0.87 | ◯ |
| 13 | — | — | 5.00 | — | — | — | 194.487 | 289.345 | 0.67 | ◯ |

As shown in Table 1, the silver/alumina polishing selectivity was 5 or higher for every one of examples 1 to 18. The higher the silver/alumina polishing selectivity is, the poorer the status of occurrence of etch pits in the polished surface of silver becomes. In terms of suppressing the occurrence of etch pits, the higher the silver/alumina polishing selectivity is, the smaller the allowable amount of overpolishing is expected to be and the more the secondary polishing using a polishing composition with a silver/alumina polishing selectivity of 1 or near 1 is to be needed. On the other hand, the lower the silver/alumina polishing selectivity is, the larger the amount of alumina to be polished off in the final stage of polishing becomes. In terms of retaining alumina, the lower the silver/alumina polishing selectivity is, the smaller the allowable amount of overpolishing is expected to be. This suggests that both too high and too low a silver/alumina polishing selectivity might reduce the allowable amount of overpolishing and make the process margin smaller. In order to secure a sufficient process margin, the silver/alumina polishing selectivity should preferably be in the range of 5 to 50, and more preferably in the range of 5 to 20. Of examples 1 to 18, examples 1 to 10 and 12 to 18 provide a silver/alumina polishing selectivity in the range of 5 to 50. Examples 1 to 9, 12 to 15, 17, and 18 allow a silver/alumina polishing selectivity in the range of 5 to 20.

From a practical standpoint, the silver polishing rate should preferably be 100 nm/min or higher. Note that if the silver polishing rate is excessively high, the silver/alumina polishing selectivity also becomes so high as to cause the above-mentioned imperfections. It is therefore preferred that the silver polishing rate be in the range of 100 to 1500 nm/min, and more preferably in the range of 100 to 1000 nm/min. Of examples 1 to 18, examples 1 to 10 and 12 to 18 provide a silver polishing rate in the range of 100 to 1500 nm/min. Examples 1 to 9 and 12 to 18 allow a silver polishing rate in the range of 100 to 1000 nm/min.

As shown in Table 2, the silver/alumina polishing selectivity was lower than 5 for every one of comparative examples 4 to 13. For comparative examples 4 to 12, the silver polishing rate was lower than 100 nm/min. From the result, it can be judged that the polishing compositions of comparative examples 4 to 13 are not practical for polishing silver and alumina.

The conditions of comparative examples 5 to 8 were the same as those of examples 1 to 4 except for the primary grain size of the silica abrasive grains. Therefore, the reason why the comparative examples 5 to 8 failed to provide a satisfactory silver/alumina polishing selectivity is that the primary grain size of the silica abrasive grains was too large. That is, the larger the primary grain size of silica abrasive grains is, the higher the mechanical polishing power of the silica abrasive grains is and the higher the resulting alumina polishing rate is. While the mechanical polishing power of the silica abrasive grains also has an influence on the silver polishing rate, chemical polishing power contributes rather greatly to the polishing of silver. Specifically, the polishing of silver is dominated by the actions of additives adhering to the surfaces of the grains. To increase the silver polishing rate, it is therefore effective to reduce the size of the grains to increase the specific surface thereof. Silica abrasive grains, or colloidal silica abrasive grains in particular, suited to increase the silver polishing rate and the silver/alumina polishing selectivity have a primary grain size of 50 nm or smaller, and preferably 30 nm or smaller. Note that the minimum grain size at which colloidal silica abrasive grains can be practically formed is around 5 nm. It is therefore preferred that the silica abrasive grains have a primary grain size in the range of 5 to 50 nm, more preferably in the range of 5 to 30 nm.

From the above discussion, a polishing composition that provides a silver polishing rate of 100 nm/min or higher, preferably in the range of 100 to 1500 nm, and more preferably in the range of 100 to 1000 nm/min, and a silver/alumina polishing selectivity of 5 or higher, preferably in the range of 5 to 50, and more preferably in the range of 5 to 20, is expected to be suited to polish silver and alumina. As can be seen from Table 1, such a polishing composition can be achieved by adjusting the respective contents of the components in the polishing composition under the following condition: the silica abrasive grain content is in the range of 0.1 to 10.0 wt %; the nitric acid content is in the range of 0.01 to 2.00 wt %; the hydrogen peroxide content is in the range of 0.1 to 2.0 wt %; and the BTA content is in the range of 0.003 to 0.050 wt %.

In contrast, typical commercially-available polishing compositions like comparative examples 1 to 3 cause silver exfoliation, and thus are not practical for polishing silver and alumina.

### EXAMPLE 19

Example 19 deals with a case where the structure shown in FIG. 5 was formed by using the polishing method according to the present embodiment. In example 19, a 1000-nm-thick insulating layer 1P of alumina was initially formed on an AlTiC wafer by the step shown in FIG. 1. Next, a plurality of trenches 1Qg were formed in the insulating layer 1P by the step shown in FIG. 2. Having undergone the formation of the trenches 1Qg therein, the insulating layer 1P becomes a support body 1Q. The support body 1Q has a surface to be polished 1Qa and the plurality of trenches 1Qg. The plurality of trenches 1Qg include three types with widths of 0.4 μm, 5.0 μm, and 50.0 μm. Each trench had an isolated straight pattern of 250 nm in depth. The 0.4-μm-wide trench 1Qg had a V-shaped cross section. This trench 1Qg with a V-shaped cross section corresponds to the trench 16Pg (FIG. 11) of the support body 16P in the process of forming the near-field light generating element 15 shown in FIG. 9 to FIG. 12. In example 19, the width of 0.4 μm of the trench 1Qg corresponds to the width of the trench that is intended for the formation of the near-field light generating element 15.

Next, a 1.5-nm-thick adhesion layer of tantalum was formed to cover the surfaces of the trenches 1Qg by the step shown in FIG. 3. Then, a 400-nm-thick silver thin film 2P was formed to fill the plurality of trenches 1Qg completely and cover the surface to be polished 1Qa.

Using the polishing composition of example 8, the silver thin film 2P and the surface 1Qa were then polished by the step shown in FIG. 4 so that the portions of the silver thin film 2P lying on the surface 1Qa were removed completely and silver thin films 2Q only remained in the trenches 1Qg. The polishing was performed over a polishing time that was calculated from the previously-determined silver polishing rate so that the silver was polished by 600 nm. The polishing was thus overpolishing. The amount of overpolishing was approximately 50% the required amount of polishing.

After the polishing, each trench 1Qg was checked for dishing. The 0.4-μm-wide trench 1Qg had a dishing recess with a depth of 36.1 nm, the 5.0-μm-wide trench 1Qg had a dishing recess with a depth of 51.6 nm, and the 50.0-μm-wide trench 1Qg had a dishing recess with a depth of 61.7 nm. None of the trenches 1Qg had etch pits in the surface of the silver embedded therein.

In example 19, even though the overpolishing was performed so that the amount of overpolishing was 50%, which was higher than a usual amount of overpolishing of around 20% to 30%, the dishing recess had a depth as small as around 60 nm even in the trench 1Qg that had a width of 50.0 μm which is 100 times or more the width of a trench intended for forming a near-field light generating element. It can therefore be seen from example 19 that the polishing composition and the polishing method according to the present embodiment can be used to provide a sufficient process margin in forming the near-field light generating element 15.

As has been described, the present embodiment makes it possible to polish the silver thin film and the surface to be polished of the object to be polished by CMP while suppressing the occurrence of imperfections.

The present invention is not limited to the foregoing embodiment, and various modifications may be made thereto. For example, the present invention is applicable not only to the case of forming a near-field light generating element of silver, but also to general cases of forming a structure in which silver is embedded in a trench of a support body, at least part of which including a polished surface is made of alumina.

It is apparent that the present invention can be carried out in various forms and modifications in the light of the foregoing descriptions. Accordingly, within the scope of the following claims and equivalents thereof, the present invention can be carried out in forms other than the foregoing most preferable embodiments.

What is claimed is:

1. A polishing composition for use in a process of polishing a silver thin film and a surface to be polished of an object to be polished by chemical mechanical polishing, the object to be polished including a support body and the silver thin film, the support body having the surface to be polished and a trench that opens in the surface to be polished, wherein at least part of the support body, including the surface to be polished, is made of alumina, and the silver thin film is formed to fill the trench of the support body,
the polishing composition containing silica abrasive grains, nitric acid, hydrogen peroxide, and benzotriazole,
the polishing composition being such one that the polishing rate of silver divided by the polishing rate of alumina in the process of polishing is equal to or higher than 5.

2. The polishing composition according to claim 1, wherein the silica abrasive grains have a primary grain size in the range of 5 to 50 nm, the silica abrasive grain content is in the range of 0.1 to 10.0 wt %, and the nitric acid content is in the range of 0.01 to 2.00 wt %.

3. The polishing composition according to claim 1, wherein the hydrogen peroxide content is in the range of 0.1 to 2.0 wt %.

4. The polishing composition according to claim 1, wherein the benzotriazole content is in the range of 0.003 to 0.050 wt %.

5. The polishing composition according to claim 1, being such one that the polishing rate of silver divided by the polishing rate of alumina in the process of polishing is in the range of 5 to 50.

6. The polishing composition according to claim 1, being such one that the polishing rate of silver divided by the polishing rate of alumina in the process of polishing is in the range of 5 to 20.

7. The polishing composition according to claim 1, wherein the silica abrasive grains have a primary grain size in the range of 5 to 50 nm, the silica abrasive grain content is in the range of 0.1 to 10.0 wt %, the nitric acid content is in the range of 0.01 to 2.00 wt %, the hydrogen peroxide content is in the range of 0.1 to 2.0 wt %, and the benzotriazole content is in the range of 0.003 to 0.050 wt %.

8. The polishing composition according to claim 1, wherein the silica abrasive grains have a primary grain size in the range of 5 to 50 nm, the silica abrasive grain content is in the range of 1.0 to 10.0 wt %, the nitric acid content is in the range of 0.1 to 2.0 wt %, the hydrogen peroxide content is in the range of 0.5 to 1.5 wt %, and the benzotriazole content is in the range of 0.005 to 0.050 wt %.

9. A concentrated polishing composition that is intended to be diluted by adding water to form the polishing composition according to claim 1.

10. A polishing method for polishing a silver thin film and a surface to be polished of an object to be polished by chemical mechanical polishing, the object to be polished including a support body and the silver thin film, the support body having the surface to be polished and a trench that opens in the surface to be polished, wherein at least part of the support body, including the surface to be polished, is made of alumina, and the silver thin film is formed to fill the trench of the support body,
the polishing method including:
supplying a polishing composition onto a polishing pad and placing the object to be polished on the polishing pad; and
polishing the silver thin film and the surface to be polished by using the polishing pad and the polishing composition, wherein:
the polishing composition contains silica abrasive grains, nitric acid, hydrogen peroxide, and benzotriazole; and
the polishing composition is such one that the polishing rate of silver divided by the polishing rate of alumina is equal to or higher than 5.
